(19) United States
(12) Patent Application Publication
(10) Pub. No.: US 2015/0138235 A1
(43) Pub. Date: May 21, 2015

(54) COLLIMATED DISPLAY DEVICE FOR AUGMENTED REALITY AND METHOD THEREOF

(71) Applicant: ELECTRONICS AND TELECOMMUNICATIONS RESEARCH INSTITUTE, Daejeon (KR)

(72) Inventors: Hyun Woo CHO, Sejong-si (KR); Hong Kee KIM, Daejeon (KR); Woo Jin JEON, Jeonju-si (KR)

(73) Assignee: ELECTRONICS AND TELECOMMUNICATIONS RESEARCH INSTITUTE, Daejeon (KR)

(21) Appl. No.: 14/549,489

(22) Filed: Nov. 20, 2014

(30) Foreign Application Priority Data
Nov. 20, 2013 (KR) 10-2013-0141150

(51) Int. Cl. G06T 19/00; G02B 27/30

(52) U.S. Cl. CPC G06T 19/006; G02B 27/30
USPC 345/633

(57) ABSTRACT

There are provided a device for displaying virtual reality overlapping the real world and a method thereof. A collimated display device for augmented reality includes a virtual image providing unit configured to modulate an image of the virtual object to light and project the result; and a collimation mirror made of a translucent material that reflects light of the image of the virtual object to a user's field of vision and provides the image of the virtual object overlapping the real world. Therefore, it is possible for the user to see an image of the virtual object that is an additional image matching the real world.

### CLAIM FOR PRIORITY

This application claims priority to Korean Patent Application No. 10-2013-0141150 filed on Nov. 20, 2013 in the Korean Intellectual Property Office (KIPO), the entire contents of which are hereby incorporated by reference.

### BACKGROUND

1. Technical Field

Example embodiments of the present invention relate to a collimated display device, and more specifically, to a device for displaying virtual reality overlapping the real world and a method thereof.

2. Related Art Augmented reality has recently been increasingly spotlighted as realistic content.

Augmented reality is technology for increasing users' immersion or providing additional information by representing a camera image of the real world with overlapping virtual content.

In order to provide realistic augmented reality, it is important to accurately match the real world and a virtual world.

Currently, most collimated display devices for providing virtual reality are see-closed types and are being generally used as military cross-cockpit training simulators and the like.

Since movement in cross-cockpit simulation is implemented using a supersized motion base having six axes or more, the collimated display device is configured as a form surrounding all windows of the cockpit to increase immersion.

According to such technology, testers see the virtual world prepared in advance through the collimated display device and feel movement while sitting in the cockpit.

In addition, since simulator devices are generally supersized devices having a large volume and cost, there is a problem in that applicability thereof is extremely limited to the military.

That is, the collimated display device in the related art and training simulator devices using the same have a problem in that movement is impossible or its use is limited in application fields in which movement is unnecessary. In addition, since the devices use a method in which the outside is completely invisible, there is a limitation that all images should be obtained in advance as the virtual world or the real image.

On the other hand, in see-through augmented reality display devices, an image of a virtual object is formed on a screen but the real world is shown to be much farther. This causes low immersion of augmented reality content due to a significant difference between an image of the real world and a virtual image.

In addition, since focal lengths of two pieces of image information are different, the user's eyes continuously attempt to focus on any side and eyes easily become tired.

### SUMMARY

Example embodiments of the present invention provide a device for displaying virtual reality overlapping the real world.

Example embodiments of the present invention also provide a method of displaying virtual reality overlapping the real world.

In some example embodiments, a collimated display device for augmented reality includes: a virtual image providing unit configured to modulate an image of the virtual object to light and project the result; and a collimation mirror made of a translucent material that reflects light of the image of the virtual object to a user's field of vision and provides the image of the virtual object overlapping the real world.

The real world may pass through the collimation minor and be provided to the user's field of vision.

In the collimation mirror, transmittance of light may be determined by brightness of the real world.

The collimation mirror may be form of a curved surface such that light beams of the image of the virtual object reflected by the collimation mirror are in parallel.

The collimation minor may have a form of a concave curved surface with respect to the user.

The virtual image providing unit may include a correction module configured to correct the image of the virtual object such the image of the virtual object matches the real world.

The virtual image providing unit may further include a projector configured to modulate the image of the virtual object to light; and a convex lens configured to guide light of the image of the virtual object such that light beams of the image of the virtual object reflected by the collimation mirror are in parallel.

In other example embodiments, in a collimation minor in which augmented reality is provided by reflecting light of an image of a virtual object, the mirror is made of a translucent material that reflects light of the image of the virtual object to a user's field of vision and provides the image of the virtual object overlapping the real world.

In still other example embodiments, a collimated display method for augmented reality includes: modulating an image of the virtual object to light and projecting the result; and reflecting light of the image of the virtual object to a user's field of vision using a collimation minor made of a translucent material and providing the image of the virtual object overlapping the real world.

In the providing of the image of the virtual object overlapping the real world, light beams of the image of the virtual object reflected by the collimation minor having a curved surface may be provided in parallel.

In the modulating of an image of the virtual object to light and projecting the result, the image of the virtual object may be corrected such that the image of the virtual object matches the real world.

The modulating of the image of the virtual object to light and projecting the result may include: modulating the image of the virtual object to light using a projector; and guiding light of the image of the virtual object using a convex lens such that light beams of the image of the virtual object reflected at the collimation mirror are in parallel.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a collimated display device for augmented reality according to an embodiment of the present invention.

FIG. 2 is a block diagram illustrating a virtual image providing unit according to an embodiment of the present invention.

FIG. 3 is a flowchart illustrating a collimated display method for augmented reality according to an embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments according to the present invention will be described in detail with reference to the accompanying drawings.

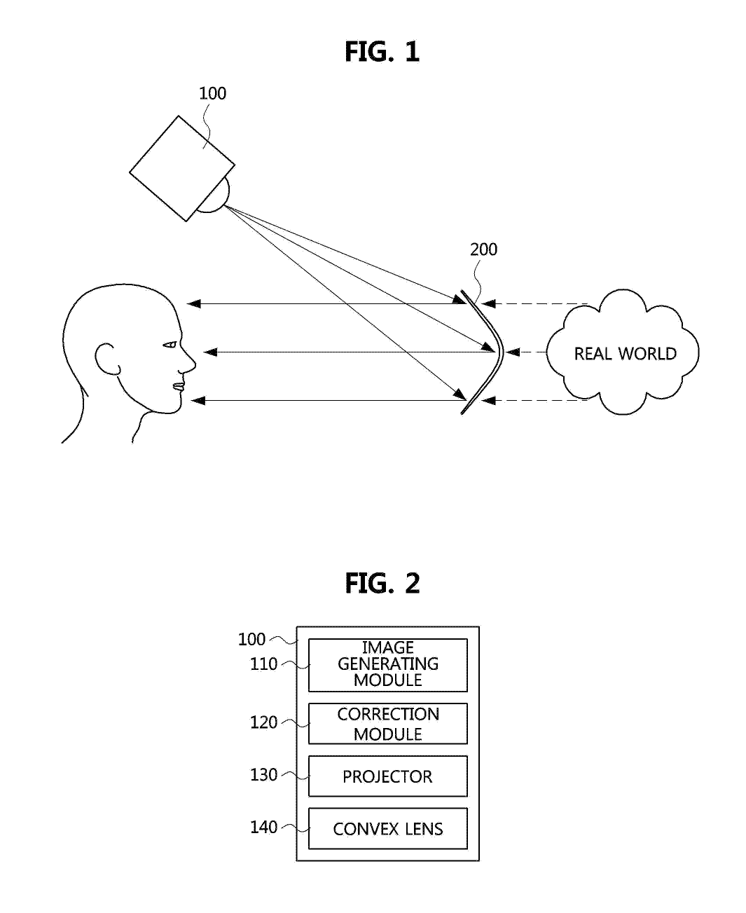

FIG. 1 is a conceptual diagram illustrating a collimated display device for augmented reality according to an embodiment of the present invention.

As illustrated in FIG. 1, the collimated display device (hereinafter referred to as a “collimated display device”) for augmented reality according to the embodiment of the present invention includes a virtual image providing unit 100 and a collimation mirror 200.

The virtual image providing unit 100 may modulate an image of a virtual object to light and project the result. The virtual image providing unit 100 may generate an image of the virtual object or obtain the image of the virtual object from an external device. The image of the virtual object may be modulated to light and projected to the collimation mirror 200. Here, the virtual object may refer to an object based on a virtual world, and the image of the virtual object may include an image representing the virtual object, additional information, and the like. That is, the virtual image providing unit 100 may provide the image of the virtual object to be overlapped on the real world (or the actual world).

The collimation mirror 200 may reflect light of the image of the virtual object to a user's field of vision and provide the image of the virtual object overlapping the real world.

Here, the real world may pass through the collimation mirror 200 and be provided to the user's field of vision. Therefore, the collimation mirror 200 may be made of a translucent material.

Specifically, the user may see the real world through the collimation mirror 200 and recognize the image of the virtual object through light of the image of the virtual object provided by the virtual image providing unit 100. Therefore, since the user recognizes the real world through the collimation mirror 200, the collimation minor 200 should be translucent. In addition, since the user recognizes light of the image of the virtual object reflected at the collimation mirror 200, the collimation mirror 200 should be made of a material capable of reflecting light.

The collimation mirror 200 is made of a translucent material which allows the image of the virtual object to overlap the real world. However, the material of the collimation mirror 200 is not specifically limited in the present invention.

Further, in the collimation mirror 200, transmittance of light may be determined by brightness of the real world. For example, transmittance (or reflectivity) of light of the collimation mirror 200 may be used as a variable for designing an appropriate value according to application fields. That is, when the minor is used to find a path in very bright outdoors, low transmittance is inconsequential, but when the mirror is used to display additional information in subways or buildings, transmittance may be set to be higher.

Meanwhile, the collimation minor 200 may be formed with a curved surface such that light of the image of the virtual object reflected at the collimation minor 200 is parallel to light of the real world. That is, since the collimation mirror 200 has a form of the curved surface, light of the image of the virtual object provided by the virtual image providing unit 100 is reflected at the collimation minor 200 and then output in parallel. In addition, the collimation minor 200 may have a form of a concave curved surface with respect to the user.

Specifically, the user may be positioned in a direction facing the minor in front of the collimation mirror 200. That is, the image of the virtual object provided from the virtual image providing unit 100 is an image that is reflected at the collimation mirror 200 and viewed by the user. The user sees the real world behind the collimation minor 200 that has passed through the collimation minor 200.

Light of the image of the virtual object reflected at the collimation minor 200 is parallel to light of the real world. That is, the image of the virtual object entering the user's eyes through the collimation minor 200 from the virtual image providing unit 100 may have an almost infinite focal length. Accordingly, the user may perceive that the image of the virtual object matches the real world rather than perceiving it as an image of the virtual object formed on the collimation minor 200

Therefore, when light of the image of the virtual object is reflected to provide augmented reality, the collimation mirror 200 may be made of a translucent material that reflects light of the image of the virtual object to the user's field of vision and therefore provides the image of the virtual object overlapping the real world.

In addition, in the collimation minor 200, transmittance of light may be determined by brightness of the real world. The collimation mirror 200 may be formed with a curved surface such that light of the image of the virtual object reflected at the collimation mirror 200 is parallel to light of the real world. Through such characteristics of the collimation minor 200, it is possible to provide the image of the virtual object matching the real world. For example, the collimation minor 200 may serves as a beam splitter.

FIG. 2 is a block diagram illustrating the virtual image providing unit 100 according to the embodiment of the present invention.

As illustrated in FIG. 2, the virtual image providing unit 100 according to the embodiment of the present invention may include an image generating module 110, a correction module 120, a projector 130 and a convex lens 140.

The image generating module 110 may generate an image of the virtual object or obtain the image of the virtual object from another external device. Here, the image of the virtual object may include an image representing the virtual object, additional information, and the like.

The correction module 120 may correct the image of the virtual object such that the image of the virtual object matches the real world. For example, the correction module 120 may correct the image of the virtual object using geometric information based on a position between the collimation mirror 200 and the virtual image providing unit 100.

The projector 130 may modulate the image of the virtual object to light. Light of the image of the virtual object generated by the projector 130 may be projected onto the collimation minor 200 through the convex lens 140.

The convex lens 140 may guide light of the image of the virtual object such that light beams of the image of the virtual object reflected at the collimation mirror 200 are in parallel.

For convenience of description, while components of the virtual image providing unit 100 have been listed as an individual component (module) and described, at least two of the components (modules) may be combined as a component (module) or one component (module) may be divided into a plurality of components (modules) to perform functions. Embodiments in which the components (modules) are combined or divided may be included in the scope of the present invention without departing from the spirit and scope of the present invention.

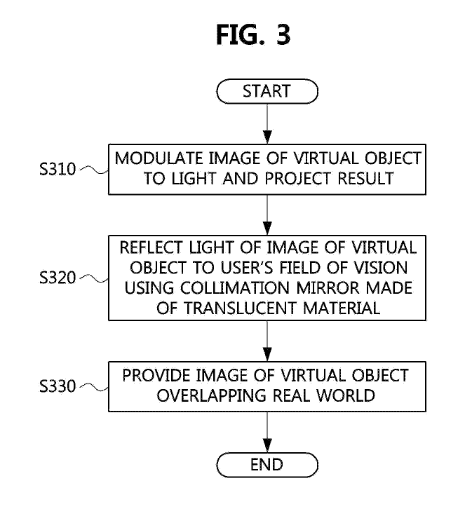

FIG. 3 is a flowchart illustrating a collimated display method for augmented reality according to an embodiment of the present invention.

As illustrated in FIG. 3, a collimated display method (hereinafter referred to as a “collimated display method”) for augmented reality according to the embodiment of the present invention includes modulating light of an image of a virtual object and projecting the result, and reflecting light of the image of the virtual object to a user's field of vision using the collimation mirror 200 made of a translucent material and providing the image of the virtual object overlapping the real world.

The image of the virtual object may be modulated to light and projected (S310).

The image of the virtual object may be corrected such that the image of the virtual object matches the real world. For example, the image of the virtual object may be corrected using geometric information based on a position between the collimation mirror 200 and the virtual image providing unit 100.

The corrected image of the virtual object may be modulated to light using the projector 130.

In addition, light of the image of the virtual object may be guided using the convex lens 140 such that light beams of the image of the virtual object reflected at the collimation minor 200 are in parallel. That is, the convex lens 140 may perform a function complementary to the collimation mirror 200 having a concave form.

Light of the image of the virtual object may be reflected to the user's field of vision using the collimation mirror 200 made of a translucent material (S320). Here, in the collimation mirror 200, transmittance of light may be determined by brightness of the real world.

For example, transmittance (or reflectivity) of light of the collimation mirror 200 may be used as a variable for designing an appropriate value according to application fields. That is, when the mirror is used to find a path in very bright outdoors, low transmittance is inconsequential, but when the mirror is used to display additional information in subways or buildings, transmittance may be set to be higher.

Light beams of the image of the virtual object reflected at the collimation minor 200 having a curved surface are set to be parallel.

The image of the virtual object overlapping the real world may be provided (S330).

Here, the real world may pass through the collimation mirror 200 and be provided to the user's field of vision.

Therefore, the image of the virtual object entering the user's eyes through the collimation minor 200 from the virtual image providing unit 100 may have an almost infinite focal length. Accordingly, the user may perceive that the image of the virtual object matches the real world rather than perceiving it as an image of the virtual object formed on the collimation mirror 200

In addition, the collimated display method according to the embodiment of the present invention may be implemented by the above collimated display device.

When the collimated display device and method according to the embodiments of the present invention are used, it is possible for the user to see an image of the virtual object that is an additional image matching the real world.

In addition, the present invention may use an infinite focal length to compensate for the problems of the see-through display device in the related art such as a sense of difference from the real world, causing dizziness due to the real world and the virtual object having different focal lengths.

In addition, according to the configuration of the present invention, when the convex lens 140 is applied to the virtual image providing unit 100 that is a screen/projection system and is integrated into a single device, mobility may be provided and an application field thereof may be extended to personal wearing types.

When the collimated display device and method according to the embodiments of the present invention are used, it is possible for the user to see an image of the virtual object that is an additional image matching the real world.

In addition, the present invention may use an infinite focal length to compensate for the problems of the see-through display device in the related art such as a sense of difference from the real world, causing dizziness due to the real world and the virtual object of different focal lengths.

In addition, according to the configuration of the present invention, when a convex lens is applied to a virtual image providing unit that is a screen/projection system and integrated into a single device, mobility may be provided and an application field thereof may be extended to personal wearing types.

While the example embodiments of the present invention and their advantages have been described above in detail, it should be understood that various changes, substitutions and alterations may be made herein without departing from the scope of the invention as defined by the following claims.

What is claimed is:

1. A collimated display device for augmented reality that is a device for providing an image of a virtual object overlapping a real world, the device comprising:
a virtual image providing unit configured to modulate an image of the virtual object to light and project the result; and
a collimation mirror made of a translucent material that reflects light of the image of the virtual object to a user's field of vision and provides the image of the virtual object overlapping the real world.

2. The device of claim 1,
wherein the real world passes through the collimation minor and is provided to the user's field of vision.

3. The device of claim 1,
wherein, in the collimation mirror, transmittance of light is determined by brightness of the real world.

4. The device of claim 1,
wherein the collimation mirror is formed with a curved surface such that light beams of the image of the virtual object reflected by the collimation mirror are in parallel.

5. The device of claim 4,
wherein the collimation mirror has a form of a concave curved surface with respect to the user.

6. The device of claim 4,
wherein the virtual image providing unit includes:
a correction module configured to correct the image of the virtual object such the image of the virtual object matches the real world.

7. The device of claim 4,
wherein the virtual image providing unit further includes:
a projector configured to modulate the image of the virtual object to light; and
a convex lens configured to guide light of the image of the virtual object such that light beams of the image of the virtual object reflected by the collimation mirror are in parallel.

8. A collimated display method for augmented reality that is a method of providing an image of a virtual object overlapping a real world, the method comprising:
modulating an image of the virtual object to light and projecting the result; and
reflecting light of the image of the virtual object to a user's field of vision using a collimation mirror made of a translucent material and providing the image of the virtual object overlapping the real world.

9. The method of claim 8,
wherein the real world passes through the collimation minor and is provided to the user's field of vision.

10. The method of claim 8,
wherein, in the collimation mirror, transmittance of light is determined by brightness of the real world.

11. The method of claim 8,
wherein, in the providing of the image of the virtual object overlapping the real world,
light beams of the image of the virtual object reflected by the collimation mirror having a curved surface are provided in parallel.

12. The method of claim 11,
wherein, in the modulating of the image of the virtual object to light and projecting the result,
the image of the virtual object is corrected such that the image of the virtual object matches the real world.

13. The method of claim 11,
wherein the modulating of the image of the virtual object to light and projecting the result includes:
modulating the image of the virtual object to light using a projector; and
guiding light of the image of the virtual object using a convex lens such that light beams of the image of the virtual object reflected by the collimation mirror are in parallel.

14. A collimation minor in which augmented reality is provided by reflecting light of an image of a virtual object, the mirror being made of a translucent material that reflects light of the image of the virtual object to a user's field of vision and provides the image of the virtual object overlapping the real world.

15. The collimation minor of claim 14,
wherein the real world passes through the collimation mirror and is provided to the user's field of vision.

16. The collimation minor of claim 14,
wherein transmittance of light is determined by brightness of the real world.

17. The collimation minor of claim 14,
wherein the minor is formed with a curved surface such that light beams of the image of the virtual object reflected by the collimation mirror are in parallel.

18. The collimation minor of claim 14,
wherein the image of the virtual object matches the real world.
